(19) United States
(12) Patent Application Publication
(10) Pub. No.: US 2020/0016997 A1
(43) Pub. Date: Jan. 16, 2020

(54) ACCOMMODATION VEHICLE MANAGEMENT APPARATUS, ACCOMMODATION VEHICLE MANAGEMENT SYSTEM, AND ACCOMMODATION VEHICLE

(71) Applicant: TOYOTA JIDOSHA KABUSHIKI KAISHA, Toyota-shi (JP)

(72) Inventors: Shoya SATO, Tokyo-to (JP); Katsuya TERAHATA, Susono-shi (JP); Yushi SEKI, Ashigarakami-gun (JP)

(73) Assignee: TOYOTA JIDOSHA KABUSHIKI KAISHA, Toyota-shi (JP)

(21) Appl. No.: 16/427,746

(22) Filed: May 31, 2019

(30) Foreign Application Priority Data
Jul. 12, 2018 (JP) 2018-132228

(51) Int. Cl. B60N 2/02; B60N 2/34; B60N 2/20; B60W 10/04; B60W 10/30; B60W 50/00; G08G 1/14; G06Q 30/02

(52) U.S. Cl. CPC B60N 2/0244; B60N 2/34; B60N 2/20; G06Q 30/0284; B60W 10/30; B60W 50/0098; G08G 1/149; B60W 10/04

(57) ABSTRACT

An accommodation vehicle management apparatus is disclosed which is configured to manage an accommodation vehicle including a reclinable seat in which a passenger sits, the reclinable seat being usable as bedding on which the passenger lies, and the accommodation vehicle being movable. The accommodation vehicle management apparatus includes a first hardware processor configured to restrict a reclining angle of the reclinable seat to less than a predetermined angle set as a reclining angle at the time of the reclinable seat being used as the bedding, at least while the accommodation vehicle is moving.

### CROSS-REFERENCE TO RELATED APPLICATION(S)

The present application claims priority to and incorporates by reference the entire contents of Japanese Patent Application No. 2018-132228 filed in Japan on Jul. 12, 2018.

### BACKGROUND

The present disclosure relates to an accommodation vehicle management apparatus and an accommodation vehicle management system that are capable of managing an accommodation vehicle enabling an in-vehicle stay, and the accommodation vehicle.

Japanese Laid-open Patent Publication JP H10-166896 A describes a vehicle including: an inter-vehicle distance sensor that detects an inter-vehicle distance to a preceding vehicle present ahead of the vehicle; a vehicle speed sensor that detects a traveling speed of the vehicle; a tracking travel control device that controls the vehicle, based on the inter-vehicle distance and the traveling speed that have been detected, such that the vehicle travels while tracking the preceding vehicle; a driver detection unit that detects whether a driver is present at the driver's seat; and a warning unit that issues a warning in accordance with a detected result of the absence of the driver. According to JP H10-166896 A, tracking travel control can be performed only in a case where the driver is sitting on the driver's seat.

However, the technique described in JP H10-166896 A is intended for a general car. Thus, automated driving complying with the legislation is difficult to provide to an accommodation vehicle having a sufficiently large space and a load, the accommodation vehicle being provided with an accommodation function, such as a bed. That is Article 55(1) of the current Road Traffic Act describes the regulation of “The driver of a vehicle must not drive while allowing a passenger to ride in a place not meant to carry a passenger, and must not drive while carrying a load in a place not meant to carry a passenger or a load”. Meanwhile, a full-flat seat is regarded as a berth rather than as a place meant to carry a passenger of the vehicle, namely, a riding accommodation (seating). Thus, because a passenger is prohibited from riding on a bed or in the sufficient large space in the accommodation vehicle during moving, detection of only the driver is insufficient. Therefore, in automated driving of the accommodation vehicle, there is room for improvement for a method of notifying a passenger in the accommodation vehicle of use of the seat, properly, with the satisfaction of the legislation.

### SUMMARY

According to a first aspect of the present disclosure, an accommodation vehicle management apparatus is provided which is configured to manage an accommodation vehicle including a reclinable seat in which a passenger sits, the reclinable seat being usable as bedding on which the passenger lies, and the accommodation vehicle being movable. The accommodation vehicle management apparatus includes a first hardware processor configured to restrict a reclining angle of the reclinable seat to less than a predetermined angle set as a reclining angle at the time of the reclinable seat being used as the bedding, at least while the accommodation vehicle is moving.

According to a second aspect of the present disclosure, an accommodation vehicle management system is provided which includes an accommodation vehicle including a reclinable seat in which a passenger sits, the reclinable seat being usable as bedding on which the passenger lies, and the accommodation vehicle being movable; and a first hardware processor configured to communicate with the accommodation vehicle, and manage the accommodation vehicle; and a second hardware processor configured to restrict a reclining angle of the reclinable seat to less than a predetermined angle set as a reclining angle at the time of the reclinable seat being used as the bedding, at least while the accommodation vehicle is moving.

According to a third aspect of the present disclosure, an accommodation vehicle being movable is provided which includes a reclinable seat in which a passenger sits, the reclinable seat being usable as bedding on which the passenger lies; and a hardware processor configured to restrict a reclining angle of the reclinable seat to less than a predetermined angle set as a reclining angle at the time of the reclinable seat being used as the bedding, at least while the accommodation vehicle is moving.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a schematic diagram of a dispatch system to which an accommodation vehicle management apparatus according to an embodiment of the present disclosure is applicable;

FIG. 2 is a schematic block diagram of the configuration of the accommodation vehicle management apparatus illustrated in FIG. 1;

FIG. 3 is a table of exemplary data of charge information stored in an operation management database of the accommodation vehicle management apparatus;

FIG. 4 is a schematic block diagram of the configuration of a parking lot managing center illustrated in FIG. 1;

FIG. 5 is a schematic block diagram of the main configuration of an accommodation vehicle illustrated in FIG. 1;

FIG. 6 is a schematic block diagram of the configuration of a safety verification unit in a controller in a vehicle terminal device mounted on the accommodation vehicle illustrated in FIG. 5;

FIG. 7 is a schematic block diagram of the configuration of a user terminal device illustrated in FIG. 1;

FIG. 8 is a flowchart for describing a processing method in the dispatch system;

FIG. 9 is a flowchart for describing a method of creating an operation plan according to the embodiment of the present disclosure illustrated in FIG. 8; and

FIG. 10 is a flowchart for describing a safety verification processing method according to the embodiment of the present disclosure illustrated in FIG. 8.

### DETAILED DESCRIPTION

Hereinafter, an embodiment of the present disclosure will be described with reference to the drawings. Note that, in all the following drawings of one embodiment, the same symbols are assigned to the same or corresponding parts. Moreover, the present disclosure is not limited by one embodiment described below.

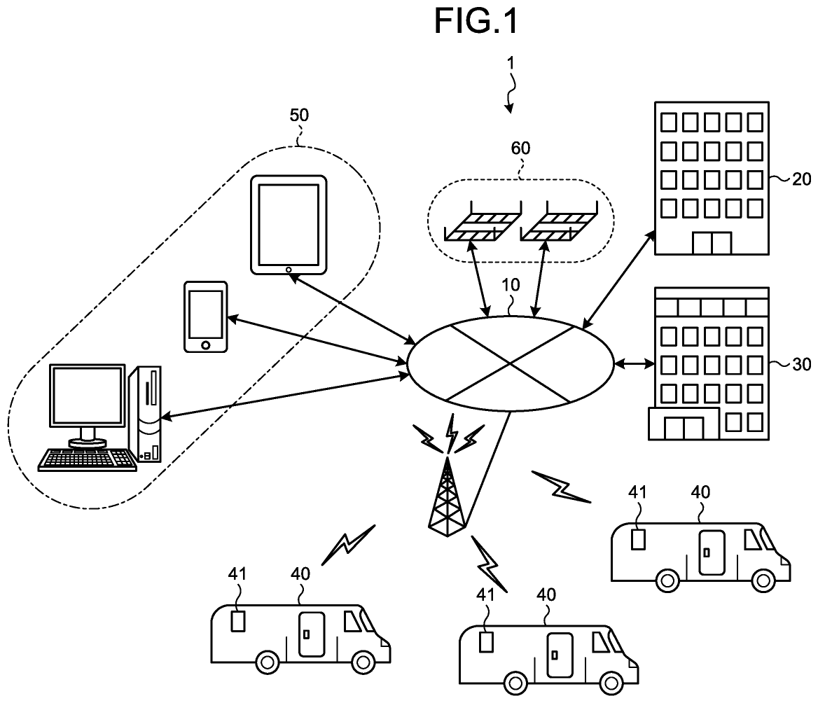

Vehicle Managing System First, a vehicle managing device according to an embodiment of the present disclosure will be described. FIG. 1 is a schematic diagram illustrating a vehicle managing system 1 as an accommodation vehicle managing system to which the vehicle managing device according to the embodiment can be applied. As illustrated in FIG. 1, the vehicle managing system 1 according to this embodiment includes a network 10, a vehicle managing apparatus 20, a parking lot managing center 30, vehicles 40 each including a vehicle terminal device 41, and user terminal devices 50. The network 10 includes the Internet line network, a cellular phone line network, or other networks that allow communication among the vehicle managing apparatus 20, the parking lot managing center 30, the vehicles 40, and the user terminal devices 50. That is, in the vehicle managing system 1 according to the embodiment, the vehicle managing apparatus 20, the parking lot managing center 30, the respective vehicles 40, and the user terminal devices 50 are connected via the network 10 so as to be communicable with one another.

Vehicle Managing Device

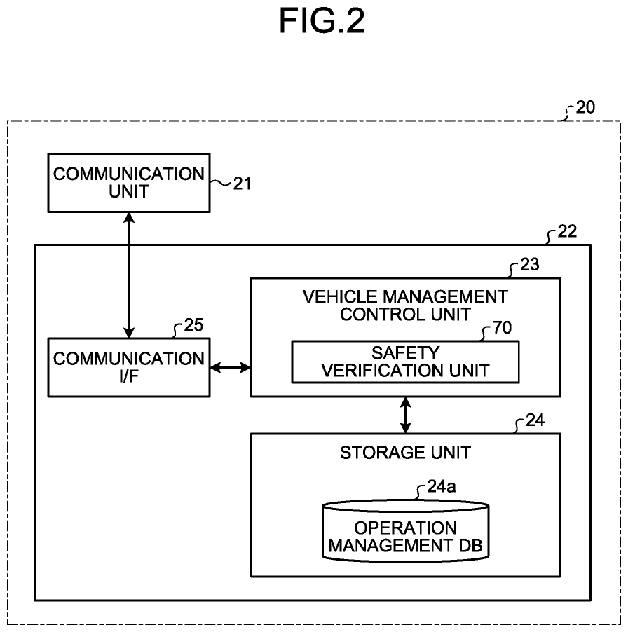

The vehicle managing apparatus 20, as an accommodation vehicle managing unit, generates an operation schedule of the vehicles 40 in accordance with requests for a plan desired by users and determines an operation plan. The vehicle managing apparatus 20 further provides the operation plan information to the vehicles 40 to manage the operation. The vehicle managing apparatus 20 provides the operation plan information to the users and also provides various types of information related to the operation of the vehicles 40. Furthermore, the vehicle managing apparatus 20 may perform safety verification process in the vehicle 40. FIG. 2 is a block diagram schematically illustrating a configuration of the vehicle managing apparatus 20.

As illustrated in FIG. 2, the vehicle managing apparatus 20 includes a communication unit 21 and a server 22. The communication unit 21 is connected with the server 22 via a communication line configured in the vehicle managing apparatus 20. The communication unit 21 connects to the network 10 to perform communication with the parking lot managing center 30, the vehicle terminal devices 41, and the user terminal devices 50.

The communication unit 21 transmits the operation plan information and a control command signal to, and receives vehicle identification information and operation state information from the vehicle terminal device 41. Note that the vehicle identification information includes information for allowing the vehicles 40 to be separately identified. The operation state information includes information indicating the operation state such as positional information and speed information regarding the operation of the vehicles 40. The communication unit 21 receives reservation state information from, and transmits parking reservation information to the parking lot managing center 30. The reservation state information includes information on whether a parking lot (or parking area) 60 is available. The parking reservation information includes information for reserving a date and time of parking and a parking position in the parking lot 60. The communication unit 21 transmits information to a user terminal device 50 owned by a user when a vehicle 40 is used, and receives user identification information for identifying the user or various types of information from the user terminal device 50.

The server 22 includes a vehicle management control unit 23, a storage unit 24, and a communication interface (I/F) 25. The vehicle management control unit 23 is configured with the main components thereof being a microcomputer including a central processing unit (CPU), a read only memory (ROM), a random access memory (RAM), etc. The vehicle management control unit 23, as an operation management unit, comprehensively controls the operations of the vehicle managing apparatus 20, particularly the server 22, related to determination of the operation plans and the operation management. The vehicle management control unit 23 includes a safety verification unit 70. Note that details of the safety verification unit 70 will be described later. The storage unit 24 includes a storage medium such as a hard disk and a semiconductor memory and a drive device for driving such storage medium, and stores various programs and various types of data in a writable and readable manner.

The storage unit 24 includes an operation management database (DB) 24a. In the operation management database 24a, user identification information and various types of information necessary for use of the vehicle 40 by the user (hereinafter also referred to as user selection information) are stored in association with each other in a retrievable manner. In the operation management database 24a, vehicle identification information and operation state information are stored in association with each other in a retrievable manner. The vehicle identification information includes information for identifying the vehicle 40. Such information can be transmitted from the vehicle terminal device 41 mounted on the vehicle 40. The communication interface 25 is for connection with a network line such as a local area network line configured within the vehicle managing apparatus 20.

The user identification information and the vehicle identification information are stored in the operation management database 24a in a retrievable manner when assigned to the user and the vehicle 40, respectively. The user identification information is registered in association with the name and address of the user and positional information such as the longitude and the latitude representing the position of the user, for example. When a user transmits predetermined information together with user identification information using the user terminal device 50, for example, the user identification information and the predetermined information are stored in association with each other in a retrievable manner in the operation management database 24a and the user information database 24b of the storage unit 24. Similarly, when the vehicle terminal device 41 transmits predetermined information such as positional information and vehicle information together with vehicle identification information, the vehicle identification information and the predetermined information are stored in association with each other at a retrievable storage position in the operation management database 24a. The vehicle information includes information such as a state of charge (SOC) of a battery, a remaining amount of fuel (fuel remaining amount), the current position, a list of insufficient items but is not necessarily limited to such information.

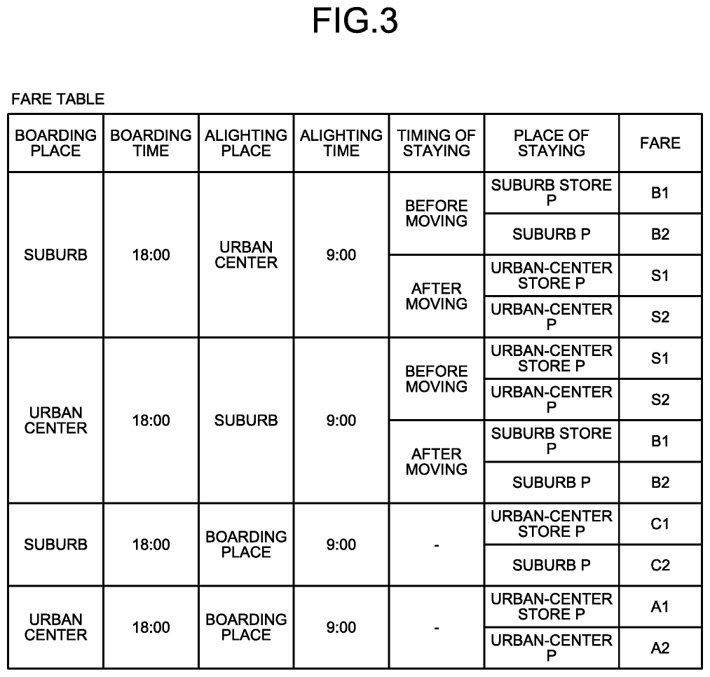

The operation management database 24a stores data of charge information. FIG. 3 is a table illustrating exemplary data of charge information used in the embodiment. As illustrated in FIG. 3, the charge information includes information of boarding locations, boarding time, alighting locations, alighting time, overnight stay timings, overnight stay locations, and charges. Note that the charge information is not limited to the above. For example, the charge information may include information such as boarding dates, alighting dates, or major roads used in an operation plan. Details of the contents of the charge information will be described later.

Parking Lot Managing Center

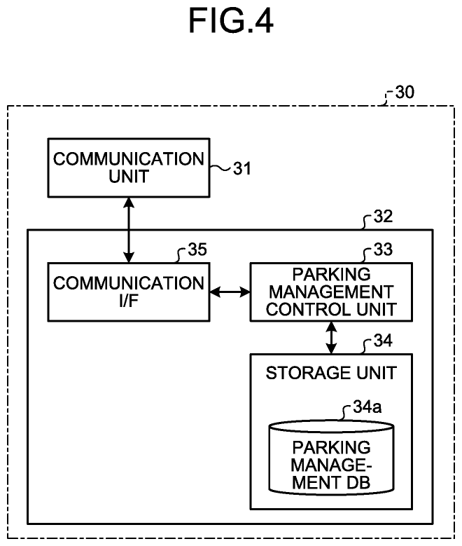

The parking lot managing center 30 is capable of retrieving the availability of the parking lots 60 at various locations in accordance with an operation plan of a vehicle 40. The parking lot managing center 30 makes a reservation for parking for each of the parking lots. FIG. 4 is a block diagram schematically illustrating a configuration of the parking lot managing center 30.

As illustrated in FIG. 4, the parking lot managing center 30 includes a communication unit 31 and a server 32. The communication unit 31 is connected with the server 32 via a communication line configured in the parking lot managing center 30. The communication unit 31 connects to the network 10 and communicates mainly with the vehicle managing apparatus 20 and managing devices of the parking lots 60 at various locations. The communication unit 31 receives vacancy status, that is, reservation state information of the parking lots 60 for each date and time from, and transmits parking reservation information for making a reservation for a date, time, period of time, etc. of using the parking lot 60 to the managing devices of the parking lots 60.

The server 32 includes a parking lot management control unit 33, a storage unit 34, and a communication interface (I/F) 35. The parking lot management control unit 33 is configured with the main components thereof being a microcomputer including a CPU, a ROM, a RAM, etc. The parking lot management control unit 33 comprehensively controls the operation of the parking lot managing center 30 that manages reservation state information and parking reservation information of the parking lots 60, particularly, the operation of the server 32. The storage unit 34 includes a storage medium such as a hard disk and a semiconductor memory and a drive device for driving such storage medium, and stores various programs and various types of data in a writable and readable manner.

The storage unit 34 includes a parking lot management database (DB) 34a. In the parking lot management database 34a, reservation state information of the parking lots 60 and other information are stored in association with parking lot identification information in a retrievable manner. The parking lot identification information includes information for identifying the parking lots 60 transmitted from the managing devices (not illustrated) of the parking lots 60 at various locations. Moreover, the parking lot identification information is registered in association with, for example, positional information of the longitude and the latitude, names of the parking lots 60, and the like. When a managing device of a parking lot 60 transmits parking lot information to the parking lot managing center 30, the parking lot identification information and the parking lot information are stored in a retrievable manner in association with each other in the parking lot management database 34a. The communication interface 35 is for connection with a network line such as a local area network (LAN) line configured within the parking lot managing center 30.

The parking lot managing center 30 receives parking lot information transmitted thereto from the managing devices of the respective parking lots 60 as necessary. The parking lot information includes at least positional information, battery charging facility information which is information whether there is a battery charging facility, and fueling facility information which is information whether there is a fueling facility capable of refueling in each of the parking lots 60. Additionally, the parking lot information may include, as necessary, reservation state information related to parking of the vehicle 40 or other vehicles 40, parking state information, and other information. Incidentally, the parking lot information may include other information such as name information or charge information of the parking lot.

Accommodation Vehicle

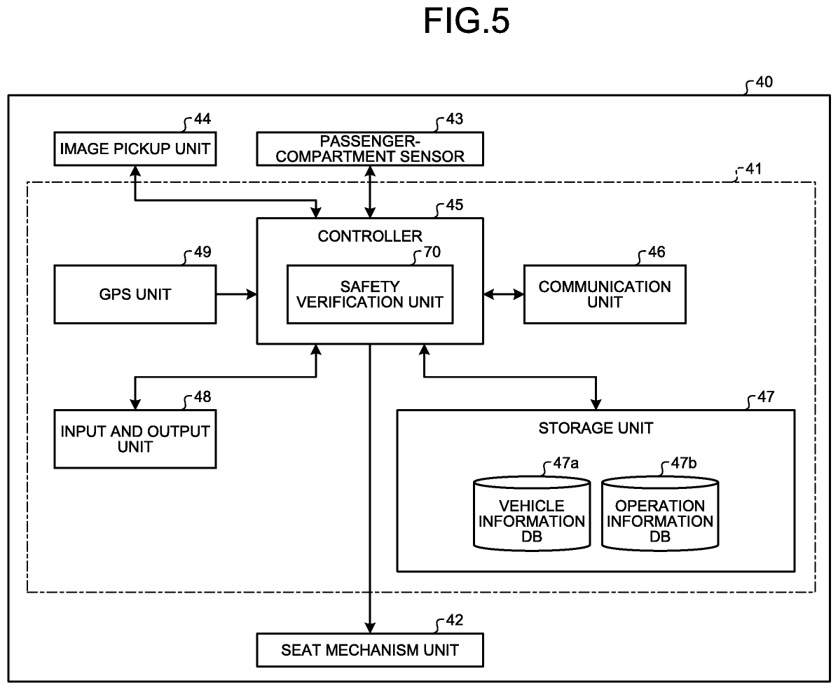

FIG. 5 is a block diagram schematically illustrating the main configuration of a vehicle 40. As illustrated in FIG. 5, the vehicle 40 includes at least the vehicle terminal device 41, a seat mechanism unit 42, a compartment interior sensor 43, and an image capturing unit 44. The vehicle 40 is a so-called accommodation vehicle or lodging vehicle including the accommodation function unit 42 (serving as temporary living quarters) that allows staying overnight (hereinafter referred to as “in-vehicle overnight stay”) in the vehicle, such as a recreational vehicle, a motor home, and a camper.

Although not illustrated, the vehicle 40 includes conventionally known facilities necessary for traveling. Specifically, the vehicle 40 includes an engine as a driving source. The engine operates on fuel and drives a generator thereby to generate electric power. The generated electric power is charged in a rechargeable battery. The vehicle 40 further includes a drive transmission mechanism that transmits the driving force of the engine, driving wheels for traveling, or the like.

The seat mechanism unit 42 includes a seat portion on which a passenger sits, a backrest inclinable backward and forward, and a mechanism capable of adjusting a reclining angle that is an angle between the backrest and a seat portion surface of the seat portion. That is, the seat mechanism unit 42 includes a reclinable seat having the seat portion and the backrest. According to this embodiment, until at least one predetermined condition is satisfied in the vehicle 40, the seat mechanism unit 42 restricts the reclining angle so as not to be a predetermined angle or more. In other words, the seat mechanism unit 42 is capable of setting the reclining angle not less than a predetermined angle when the predetermined condition is met. The seat mechanism unit 42 can be controlled at least by a controller 45.

The seat of the seat mechanism unit 42 satisfies the following two requirements for enabling serving as a sleeping tool and a sitting tool of a riding accommodation. That is, first, the seat is manufactured on the premise that the seat portion surface and the backrest of the seat in the riding accommodation can be used as the sleeping tool. Second, in a case where the seat portion surface and the backrest of the seat in the riding accommodation are used as the sleeping equipment, the entire upper face of the sleeping equipment has a continuous flat face. Note that, in the present specification, the sleeping equipment is also referred to as bedding or a bed. Here, a mode in which the seat mechanism unit 42 has the seat portion surface and the backrest of the seat ready to be used as the sleeping equipment is defined as a bed mode. In the bed mode, the reclining angle is secured at a predetermined angle set as a while-asleep reclining angle (or a reclining angle at the time of the seat being used as a bed). Meanwhile, a mode in which the seat is used as the riding accommodation is defined as a seat mode. In the seat mode, the reclining angle is set so as to be changed by a passenger to a desired angle in the range less than the predetermined angle set as the while-asleep reclining angle.

On the other hand, the current legislation describes the regulation of “The driver of a vehicle must not drive while allowing a passenger to ride in a place not meant to carry a passenger, and must not drive while carrying a load in a place not meant to carry a passenger or a load”. In this case, when the reclining angle is the predetermined angle in the bed mode, the place is not regarded as a place meant to carry a passenger of the vehicle. Thus, the predetermined angle as the reclining angle in the bed mode of the seat mechanism unit 42 allows a portion used as the seat (or a sitting tool) in the seat mode in traveling of the vehicle 40, to function as bedding (or a bed), the predetermined angle being set as the while-asleep reclining angle. The predetermined angle that is the reclining angle allowing the seat to be regarded as bedding is specifically 150° or more, favorably 170° or more, more favorably 180°. Note that, in a case where a cushion of the seat portion of the seat mechanism unit 42 is large in thickness, the predetermined angle in the bed mode is allowed to approximately 190°. Thus, the predetermined angle is preferably 190° or less. When the seat of the seat mechanism unit 42 is ready to function as bedding, use of the seat in a passenger compartment of the vehicle 40 results in use of the vehicle 40 as a facility with bedding. Thus, the use of the seat is defined as “accommodation” according to the Japanese Inns and Hotels Act.

The compartment interior sensor 43 is capable of detecting various states in the passenger compartment of the vehicle 40. Particularly, the compartment interior sensor 43 is capable of detecting a state of a so-called accommodation functional unit (not illustrated) including the bed, home electronics, such as a refrigerator, and other devices necessary for accommodation, in the passenger compartment of the vehicle 40. For example, the compartment interior sensor 43 can detect whether a person or an object is on the bed or whether the door of the refrigerator is locked. Furthermore, the compartment interior sensor 43 is capable of detecting a state of an object, such as a suitcase or a load brought in the passenger compartment or the passenger in the passenger compartment, that is not the so-called accommodation functional unit (hereinafter, referred to as an accommodation unfunctional object). Examples of the state of the accommodation unfunctional object that the compartment interior sensor 43 detects may include whether the suitcase is secured, whether, for example, the load being unsecured is developed, and whether the passenger is sitting, for example, on the floor. Note that the state of the accommodation functional unit and the state of the accommodation unfunctional object that the compartment interior sensor 43 detects are not limited to the examples. The compartment interior sensor 43 is capable of detecting various states necessary in the safety verification process to be described later. The compartment interior sensor 43 measures the passenger compartment of the vehicle 40 continuously or intermittently at predetermined times.

The image capturing unit 44 includes an image capturing device, such as a camera. The image capturing unit 44 is capable of capturing various states in the passenger compartment of the vehicle 40. Particularly, the image capturing unit 44 is capable of capturing the state of the accommodation unfunctional object, such as the suitcase or the load in the passenger compartment or the passenger in the passenger compartment. Examples of the state of the accommodation unfunctional object that the image capturing unit 44 captures may include the securing state of the suitcase, the development state of the load, and the posture of the passenger. The image capturing unit 44 may be capable of capturing the state of the accommodation functional unit (not illustrated) in the passenger compartment of the vehicle 40. In this case, for example, the image capturing unit 44 can detect whether a person or an object is on the bed or whether the door of the refrigerator is locked. Note that the state of the accommodation functional unit and the state of the accommodation unfunctional object that the image capturing unit 44 captures are not limited to the examples. The image capturing unit 44 is capable of capturing various objects necessary in the safety verification process to be described later. As necessary, the image capturing unit 44 may include an image scanning device, such as a scanner, or a sensor capable of performing biometric authentication, such as an iris sensor, a fingerprint sensor, or a regular pulse sensor. The image capturing unit 44 captures the passenger compartment of the vehicle 40 continuously or intermittently at predetermined times.

The vehicle 40 is an accommodation vehicle that does not have any operation route and operation time previously determined (hereinafter, referred to as an operation plan), the accommodation vehicle being to travel in accordance with the operation plan appropriately determined by the vehicle managing apparatus 20 in response to a demand or an instruction of the user. Thus, the vehicle 40 is provided with the vehicle terminal device 41 capable of transmitting and receiving various types of information including the operation plan information through communication with the vehicle managing apparatus 20. The vehicle terminal device 41 includes the controller 45, a communication unit 46, a storage unit 47, an input and output unit 48, and a global positioning system (GPS) unit 49.

The communication unit 46 communicates with the vehicle managing apparatus 20 through wireless communication through the network 10. The storage unit 47 includes storage media, such as a hard disk and a semiconductor memory, and a drive device for the storage media. The storage unit 47 serving as a storage stores an operating system (OS) and various applications, necessary for the controller 45 to comprehensively control the actuation of the vehicle terminal device 41. The storage unit 47 includes a vehicle information database (DB) 47a and an operation information database (DB) 47b. The vehicle information database 47a stores various types of information including the state of charge of a battery, the remaining amount of fuel, the current position, and a list of insufficient items, updatably. The operation information database 47b stores various types of data including the operation plan information provided from the vehicle managing apparatus 20, updatably.

For example, the input and output unit 48 is configured of a touch-panel display, a speaker microphone, and the like. The input and output unit 48 serving as an output unit is capable of conveying to the outside predetermined information, such as the operation plan information, with display of text or a figure on the screen of the touch-panel display or output of voice from the speaker microphone, in accordance with the control of the controller 45. The input and output unit 48 serving as an input unit is capable of inputting predetermined information to the controller 45 with an operation of the user to the touch-panel display or a voice of the user to the speaker microphone.

The GPS unit 49 receives a radio wave from a global positioning system (GPS) satellite, to detect the location of the vehicle 40 equipped with the vehicle terminal device 41. The detected location is stored as the location information in the vehicle information into the vehicle information database 47a, the detected location being searchable. The controller 45 is capable of determining whether the vehicle 40 is located in the parking lot 60 for staying (overnight(s)) as the place of staying (or the place where the user(s) or passenger(s) stay overnight(s) in the vehicle 40), based on the location information output from the GPS unit 49. The controller 45 serving as a parking determination unit is capable of determining whether the vehicle 40 has been parked in the parking lot 60 for staying, based on speed information and movement distance information regarding the vehicle 40 and the location information detected by the GPS unit 49.

The controller 45 of the vehicle terminal device 41 includes, as a main constituent component, a microcomputer including a CPU, a ROM, and a RAM. The controller 45 comprehensively controls the operation of the vehicle terminal device 41 mounted on the vehicle 40.

Accommodation Vehicle Safety Verification Unit

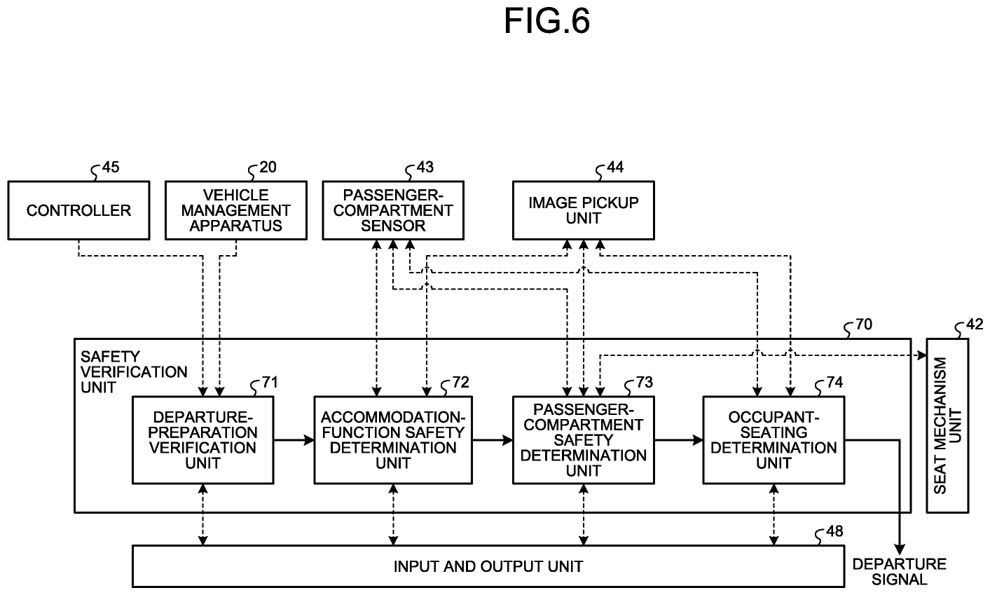

The controller 45 includes a safety verification unit 70. FIG. 6 is a schematic block diagram of the configuration of the safety verification unit 70 in the controller 45 of the vehicle terminal device 41. An exemplary safety verification process of the safety verification unit 70 in the controller 45 of the vehicle terminal device 41 will be explained in the following. The exemplary safety verification process is similar to the safety verification process of the safety verification unit 70 in the vehicle management controller 23 (FIG. 2) of the vehicle managing apparatus 20. The arrows in FIG. 6 indicate input and output of data, information, or a signal, and the broken arrows indicate input and output of data, information, or a signal, between the vehicle 40 and the vehicle managing apparatus 20 through the network 10, in addition to input and output of as data, information, or a signal, in the vehicle management controller 23 and in the controller 45.

As illustrated in FIG. 6, the safety verification unit 70 according to the embodiment includes a departure-preparation verification unit 71, an accommodation-function safety determination unit 72, a passenger-compartment safety determination unit 73, and an occupant-seat determination unit 74.

The departure-preparation verification unit 71 serving as a departure-preparation verifier is supplied with various types of information including information regarding, for example, the drive of the vehicle 40, from the remaining controller except the safety verification unit 70 in the controller 45 of the vehicle terminal device 41. The departure-preparation verification unit 71 is supplied with various types of information including information regarding, for example, the operation plan information for the vehicle 40, from the remaining controller except the safety verification unit 70 in the vehicle management controller 23 of the vehicle managing apparatus 20. The departure-preparation verification unit 71 verifies whether the vehicle 40 is in a departure enabling state, based on the respective various types of information supplied from the vehicle management controller 23 and the controller 45. For example, in a case where the intention of causing the vehicle 40 to depart has been input in the vehicle 40 after the user switches the ignition of the vehicle 40 on or inputs an instruction for departure into the controller 45 of the vehicle 40, the departure-preparation verification unit 71 supplies a departure enabling signal to the accommodation-function safety determination unit 72. Note that, for example, a case where the current time indicates a specific time, such as the departure time in the operation plan, a case where the motor generator (MG) of the vehicle 40 starts, or a case where the number of passengers on board the vehicle 40 reaches the number of passengers that has registered in advance can be set as the departure enabling state. The definition of the departure enabling state can be previously set. The departure-preparation verification unit 71 stores information as a determination criterion of whether the departure enabling state is satisfied.

When the accommodation-function safety determination unit 72 serving as an accommodation-function safety determiner is supplied with the departure enabling signal, the accommodation-function safety determination unit 72 controls the compartment interior sensor 43 and collects various detected results regarding the accommodation functional unit, detected by the compartment interior sensor 43. The accommodation-function safety determination unit 72 determines whether the accommodation functional unit in the passenger compartment is safe, based on the collected detected results. Similarly, the accommodation-function safety determination unit 72 controls the image capturing unit 44 and collects various types of captured data regarding the accommodation functional unit, captured by the image capturing unit 44.

The accommodation-function safety determination unit 72 determines whether the accommodation functional unit in the passenger compartment is safe, based on the collected captured data. Note that, for the collection of the information regarding the safety of the accommodation functional unit, either one of the compartment interior sensor 43 and the image capturing unit 44 may only be used. Here, the safety of the accommodation functional unit means, for example, that no various devices drop or move, or no door opens in traveling of the vehicle 40. In other words, the safety of the accommodation functional unit means that no part of the accommodation functional unit hiders any passenger or any object in the passenger compartment in traveling of the vehicle 40. For example, in a case where a person or an object is on the bed, there is a possibility that the person or the object drops in traveling of the vehicle 40, to hinder another object or another passenger in the passenger compartment. In a case where the door of the refrigerator is not locked, there is a possibility that the door of the refrigerator opens in traveling of the vehicle 40 to cause objects in the refrigerator to drop or to collide against another object or a passenger, resulting in an obstacle to the object or the passenger in the passenger compartment. Thus, the accommodation-function safety determination unit 72 determines the safety of each of the various devices included in the accommodation functional unit, such as whether a person or an object is on the bed or whether the door of the refrigerator is locked.

In a case where it is determined that the accommodation functional unit is safe, the accommodation-function safety determination unit 72 supplies the passenger-compartment safety determination unit 73 with a signal (accommodation-function safety signal) indicating that the accommodation functional unit is safe. Meanwhile, in a case where determining that the accommodation functional unit is not safe, the accommodation-function safety determination unit 72 outputs a signal (accommodation-function failure signal) indicating that the current state of the accommodation functional unit is not safe. When the input and output unit 48 is supplied with the accommodation-function failure signal output by the accommodation-function safety determination unit 72, the input and output unit 48 displays and voice-outputs information indicating that the state of the accommodation functional unit should be made safe because the current state of the accommodation functional unit is not safe, on the touch-panel display and from the speaker microphone, respectively. With this, the passengers who are the occupants of the vehicle 40 are notified that the current state of the accommodation functional unit should be made safe, in the vehicle 40.

When the passenger-compartment safety determination unit 73 serving as a passenger-compartment safety determiner is supplied with the accommodation-function safety signal, the passenger-compartment safety determination unit 73 controls the image capturing unit 44 and collects various types of captured data regarding the accommodation unfunctional object in the passenger compartment, captured by the image capturing unit 44. Similarly, the passenger-compartment safety determination unit 73 controls the compartment interior sensor 43 and collects various detected results regarding the accommodation unfunctional object in the passenger compartment, detected by the compartment interior sensor 43. The passenger-compartment safety determination unit 73 determines whether the accommodation unfunctional object in the passenger compartment is safe, based on the collected detected results. The passenger-compartment safety determination unit 73 determines whether the accommodation unfunctional object in the passenger compartment is safe, based on the collected captured data. Note that, for the collection of the information regarding the state of the passenger compartment, either one of the compartment interior sensor 43 and the image capturing unit 44 may only be used. Here, the safety of the passenger compartment means, for example, that no suitcase is secured or moves, no load has been scattered, or no one is sitting on the floor in traveling of the vehicle 40. In other words, the safety of the passenger compartment means that no accommodation unfunctional object hinders any passenger, any object in the passenger compartment, or the structure of the vehicle 40 in traveling of the vehicle 40. Thus, preferably, the compartment interior sensor 43 includes a group of sensors attached to places at which an unsafe state is assumed to occur in the passenger compartment, for example, including a sensor attached to equipment that secures a suitcase.

Furthermore, the passenger-compartment safety determination unit 73 detects the reclining angle of the seat mechanism unit 42, to determine whether a seat serving as a bedding is present in the passenger compartment. That is, the passenger-compartment safety determination unit 73 serving as a seat regulation unit of the safety verification unit 70 determines whether a seat having a reclining angle not less than the predetermined angle set as the while-asleep reclining angle is present in the seat mechanism unit 42. In a case where it is determined that a seat having a reclining angle not less than the predetermined angle is present in the seat mechanism unit 42, the passenger-compartment safety determination unit 73 outputs an angle control signal for controlling the reclining angle less than the predetermined angle, to the seat mechanism unit 42. With this, the reclining angle is restricted to less than the predetermined angle, resulting in the seat mode in the seat mechanism unit 42. When the reclining angle of each seat of the seat mechanism unit 42 is restricted to less than the predetermined angle, the passenger-compartment safety determination unit 73 determines that the reclining angle in the seat mechanism unit 42 is less than the predetermined angle.

In a case where it is determined that the passenger compartment is safe and it is determined that the reclining angle is less than the predetermined angle in the seat mechanism unit 42, the passenger-compartment safety determination unit 73 supplies a signal (passenger-compartment safety signal) indicating that the passenger compartment is safe, to the occupant-seat determination unit 74. Meanwhile, in a case where it is determined that the passenger compartment is not safe, the passenger-compartment safety determination unit 73 outputs a signal (passenger-compartment failure signal) indicating that the current state of the passenger compartment is not safe. When the input and output unit 48 is supplied with the passenger-compartment failure signal output by the passenger-compartment safety determination unit 73, the input and output unit 48 displays and voice-outputs information indicating that the state of the accommodation unfunctional object in the passenger compartment should be made safe because the current state of the passenger compartment is not safe, on the touch-panel display and from the speaker microphone, respectively. With this, the passengers who are the occupants of the vehicle 40 are notified that the current state of the passenger compartment should be made safe, in the vehicle 40.

When the occupant-seat determination unit 74 serving as a passenger-seat determination unit is supplied with the passenger-compartment safety signal, the occupant-seat determination unit 74 controls the compartment interior sensor 43 and collects various detected results regarding the seat mechanism unit 42, detected by the compartment interior sensor 43. Similarly, the occupant-seat determination unit 74 controls the image capturing unit 44 and collects various types of captured data regarding the seat mechanism unit 42 in the passenger compartment, captured by the image capturing unit 44. The occupant-seat determination unit 74 determines whether all the passengers have been seated on the respective seats with the seat belts fastened in the passenger compartment, based on the collected detected results and the collected captured data. Note that, for the collection of the information regarding the seat of the passengers and the fastening of the seat belts, either one of the compartment interior sensor 43 and the image capturing unit 44 may only be used.

When determining that all the passengers have been seated on the respective seats with the seat belts fastened, the occupant-seat determination unit 74 outputs a signal (departure signal) indicating that the vehicle 40 is allowed to depart. Meanwhile, when determining that at least one of the passengers has not been seated on the seat or has not fasten the seat belt, the occupant-seat determination unit 74 outputs a signal (departure failure signal) indicating that the vehicle 40 is not allowed to depart. When the input and output unit 48 is supplied with the passenger-compartment failure signal output by the occupant-seat determination unit 74, the input and output unit 48 displays and voice-outputs information indicating that the passengers should be seated on their seats and fasten the seat belts, on the touch-panel display and from the speaker microphone, respectively. With this, the passengers who are the occupants of the vehicle 40 are notified that they should be seated and fasten their seat belts.

Incidentally, the determination of whether a seat serving as a bedding is present, with the detection of the reclining angle of the seat mechanism unit 42, and the control of regulating the reclining angle, described above, may be performed by the departure-preparation verification unit 71, the accommodation-function safety determination unit 72, or the occupant-seat determination unit 74. In a case where the departure-preparation verification unit 71 performs the determination, when it is determined that the departure enabling state described above is satisfied and determined that no seat serving as a bedding is present, the departure-preparation verification unit 71 outputs the departure enabling signal. In a case where the accommodation-function safety determination unit 72 performs the determination, when it is determined that the accommodation functional unit is safe and determined that no seat serving as a bedding is present, the accommodation-function safety determination unit 72 outputs the accommodation-function safety signal. In a case where the occupant-seat determination unit 74 performs the determination, when it is determined that all the passengers have been seated on the seats with the seat belts fastened and determined that no seat serving as a bedding is present, the occupant-seat determination unit 74 outputs the departure signal. Furthermore, as the seat regulation unit, the controller 45 or the safety verification unit 70 can perform the regulation of the reclining angle of the seat mechanism unit 42.

User Terminal Device

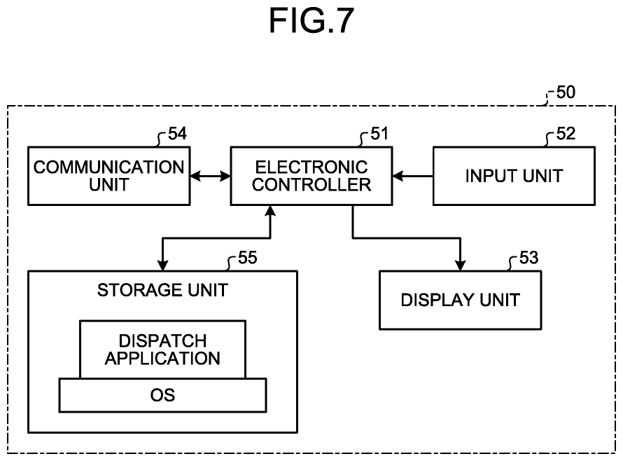

The user terminal device 50 serving as a user terminal is operated by a user who is at least one of the passengers on board the vehicle 40. For example, with various types of data due to a communication application or a call with voice, the user terminal device 50 transmits various types of information, such as user information including the user identification information and the user selection information, to the vehicle managing apparatus 20. The user identification information includes information regarding, for example, a user ID and a password, necessary for access to the vehicle managing apparatus 20 in the transmission of the user information. The user terminal device 50 is capable of receiving various types of information, such as the operation plan information, a vehicle assignment approval signal, and data of an electronic key, from the vehicle managing apparatus 20. FIG. 7 is a schematic block diagram of the configuration of the user terminal device 50.

As illustrated in FIG. 7, the user terminal device 50 includes an electronic controller 51, an input unit 52, a display unit 53, a communication unit 54, and a storage unit 55 that are connected mutually communicably. The electronic controller 51 includes, as a main constituent component, a microcomputer including a CPU, a ROM, and a RAM. The electronic controller 51 comprehensively controls the operation of the input unit 52, the display unit 53, the communication unit 54, and the storage unit 55, due to execution of various application programs.

For example, the input unit 52 includes a keyboard, a touch-panel keyboard, such as a touch-panel display, embedded inside the display unit 53, the touch-panel keyboard being to detect a touch operation of a display panel, or a voice input device, such as a speaker microphone, enabling a call with the outside. Here, specifically, the call with the outside is a call with, for example, an operator or an artificial intelligence system resident in the vehicle managing apparatus 20. The display unit 53 including, for example, an organic EL panel or a liquid-crystal display panel, displays text or a figure on the display panel to convey information outward.

The communication unit 54 has a function of transmitting and receiving various types of information, such as the user identification information, the user selection information, the operation plan information, and voice data, in cooperation with the vehicle managing apparatus 20 in connection with the network 10. The storage unit 55 stores the various application programs including an OS and a vehicle assignment application (hereinafter, referred to as a vehicle assignment app), for the electronic controller 51 to control the operation of the user terminal device 50, and various types of data. The storage unit 55 is capable of storing the user identification information.

Specific examples of the user terminal device 50 described above, that can be adopted, include a mobile phone, such as a smartphone, an information terminal, such as a tablet, and a personal computer. Note that a desktop personal computer located, for example, at home, or a land-line phone located, for example, at home can be used.

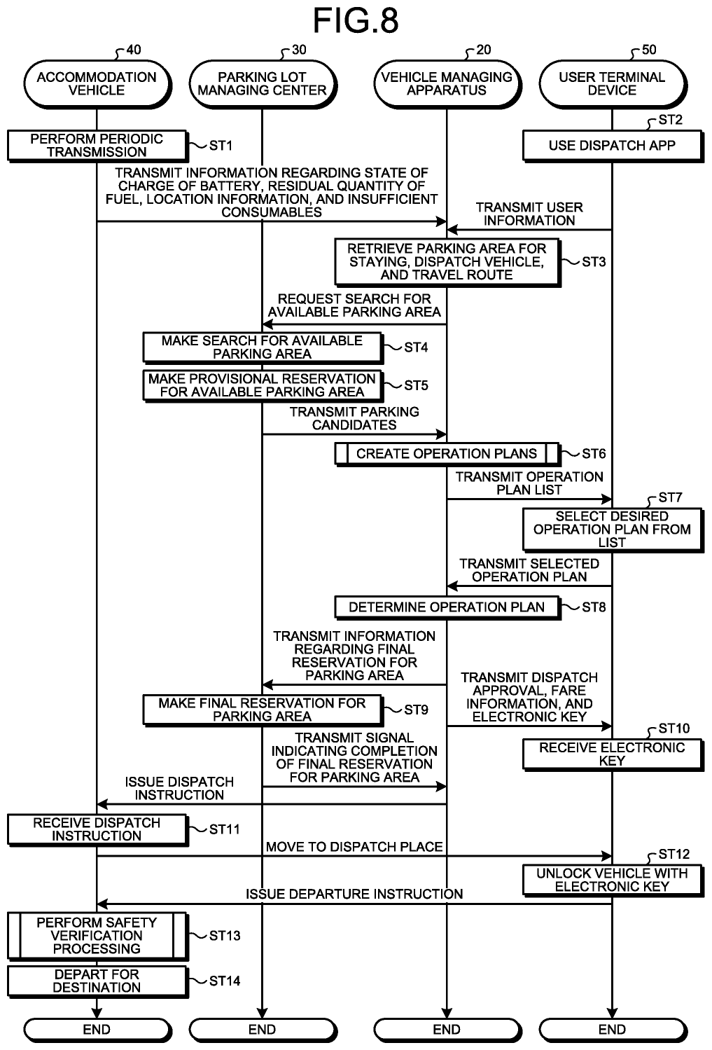

Vehicle Assignment Processing Method Next, a vehicle assignment processing method including creating an operation plan, according to the embodiment of the present disclosure, in the vehicle management system 1 having the configuration described above, will be described. FIG. 8 is a flowchart for describing the processing method in the vehicle management system 1.

As illustrated in FIG. 8, first in step ST1, various types of information related to the vehicles 40 is periodically transmitted from each of the plurality of vehicles 40 to the vehicle managing apparatus 20. Here, the term “periodic” means every predetermined period of time such as every hour or every three hours. Note that, in the following description, transmission and reception of information is performed via the network 10; however, explanation as such on each item is omitted. The vehicle management control unit 23 of the vehicle managing apparatus 20 stores vehicle information received via the communication unit 21 and the communication interface 25 in the storage unit 24 in association with the vehicle identification information of each of the vehicles 40.

Meanwhile, in step ST2, operation of the user terminal device 50 by the user results in activation of the vehicle assignment app (application) in the user terminal device 50. Note that step ST2 is executed independently of step ST1. The vehicle assignment app is activated and executed based on an operation program such as an OS stored in the user terminal device 50. The user terminal device 50 in which the vehicle assignment app is executed transmits user identification information input by the user or stored in the user terminal device 50 to the vehicle managing apparatus 20. Hereinafter, in the user terminal device 50, transmission and reception of various types of information and storage of information in the storage unit 55 or other components upon use of the vehicle managing system 1 is executed by the vehicle assignment app as appropriate.

The user terminal device 50 transmits user selection information input by the user using the user terminal device 50 to the vehicle managing apparatus 20 as user information together with the user identification information. Note that the user selection information selectively contains necessary information out of: boarding positional information including a boarding location that the user desires; alighting positional information including an alighting location; boarding/alighting positional information including boarding positional information and alighting positional information; boarding time information including boarding time; alighting time information including alighting time; and overnight stay timing information including an overnight stay timing. The overnight stay timing indicates that a parking lot 60 where the user wishes to stay overnight is closer to the boarding location or the alighting location, in this embodiment. Namely, an overnight stay timing closer to the boarding location is regarded as being before traveling to (arriving at) the alighting position, whereas an overnight stay timing closer to the alighting location is regarded as being after traveling to (arriving at) the alighting position. The overnight stay timing information includes information as to before or after traveling to the alighting position selected by the user. The vehicle management control unit 23 of the vehicle managing apparatus 20 stores the user selection information received via the communication unit 21 and the communication interface 25 in the storage unit 24 in association with each piece of the user identification information.

Thereafter, in step ST3, the vehicle managing apparatus 20 searches for a vehicle 40 to be assigned to the user, a parking lot 60 where to stay overnight (also referred to as an overnight stay parking lot 60), and a traveling route on the basis of the received vehicle information and the user information. Here, the overnight stay parking lot is a parking lot 60 to park at for the user or other people to stay overnight in the retrieved vehicle 40. The vehicle 40 to be assigned is a vehicle 40, out of the respective vehicles 40, which is moved such that the user can board. The traveling route is a traveling route on accessible roads, which is selected depending on the purpose-specific traveling pattern of the traveling of the vehicle 40 on the basis of the user selection information transmitted from the user terminal device 50. The vehicle management control unit 23 searches for a time period during which the vehicle 40 is parked in the overnight stay parking lot 60 on the basis of the searched traveling route. The vehicle managing apparatus 20 transmits, to the parking lot managing center 30, a search request signal for an overnight stay parking lot (hereinafter referred to as an vacant parking lot) where the vehicle 40 can be parked during the time period which is located along the searched traveling route.

After step ST3, the vehicle managing apparatus 20 transmits a search request signal for a vacant parking lot to the parking lot managing center 30. As a result, in step ST4, the parking lot management control unit 33 of the parking lot managing center 30 retrieves vacant parking lots located along the traveling route on the basis of the search request signal for a vacant parking lot received from the vehicle managing apparatus 20 and the time period of parking of the vehicle 40. Note that the parking lot managing center 30 stores the received parking lot information in the parking lot management database 34a of the storage unit 34 as necessary in association with the parking lot identification information of each of the parking lots 60.

Subsequently, in step ST5, the parking lot managing center 30 transmits parking reservation information to a vacant parking lot to make a so-called provisionary reservation in order to temporarily disable reservation of the searched vacant parking lot by another vehicle at time and the time period to park in the parking lot on the basis of the traveling route of the vehicle 40. Here, the parking reservation information includes parking start time when parking of the vehicle 40 in the parking lot 60 starts, parking end time to depart from the parking lot, parking position information for selecting a position to park in the parking lot 60, and so on. Note that the parking reservation information may include other information. The parking lot managing center 30 transmits the list information of the plurality of vacant parking lots (hereinafter referred to as candidate parking lots) where the aforementioned provisional reservation has been made to the vehicle managing apparatus 20.

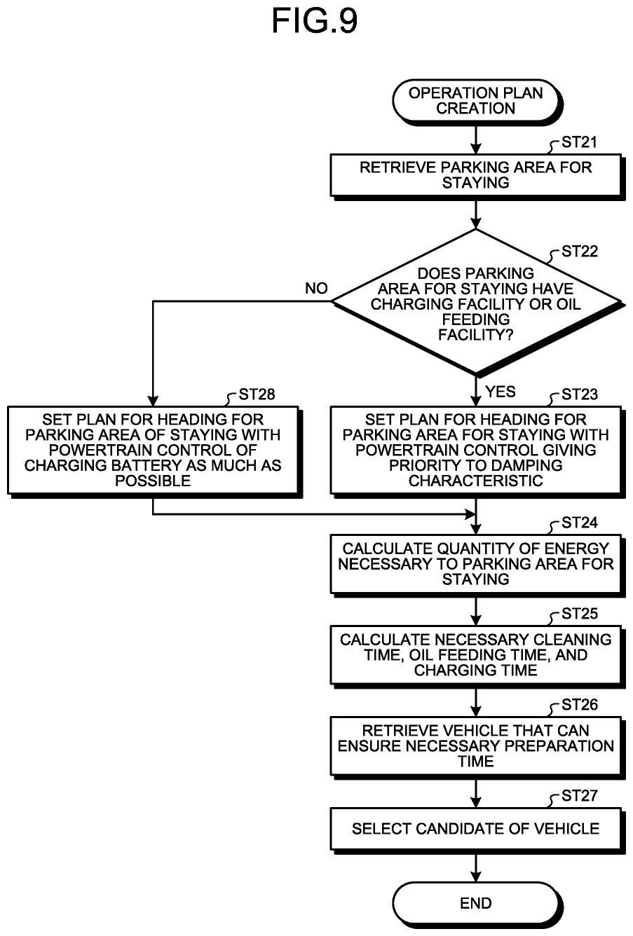

Thereafter, in step ST6, the vehicle managing apparatus 20 generates a plurality of operation plans. Here, a specific example of a method of generating an operation plan will be described. FIG. 9 is a flowchart for explaining a method of generating the operation plan illustrated in FIG. 8.

As illustrated in FIG. 9, in the method of generating an operation plan according to this embodiment, the vehicle management control unit 23 first, in step ST21, searches parking lot information of the overnight stay parking lot 60 from the operation management database 24a of the storage unit 24 on the basis of the list information of candidate parking lots received from the parking lot managing center 30. As described above, the parking lot information includes various types of information such as positional information, battery charging facility information, fueling facility information, reservation state information, and parking state information of at least each of the parking lots 60.

Next, moving on to step ST22, the vehicle management control unit 23 determines whether at least one of a battery charging facility and a fueling facility exists is available in the overnight stay parking lot 60 on the basis of the parking lot information of the searched overnight stay parking lot 60. If it is determined that a battery charging facility or a fueling facility is available in the searched overnight stay parking lot 60, the vehicle management control unit 23 proceeds to step ST23.

In step ST23, the vehicle management control unit 23 sets to perform power train control, which is travel control in which vibration damping performance is prioritized, in the vehicle 40 on the basis of the traveling route searched in the above step ST3. In this manner, a plurality of operation plans is planned that can ensure vibration damping performance as much as possible in the vehicle 40.

Next, the flow proceeds to step ST24. In step ST24, the vehicle management control unit 23 calculates the amount of energy required from the departing location to the overnight stay parking lot on the basis of the plurality of operation plans set to perform the power train control in which vibration damping performance is prioritized. Then, moving on to step ST25, the vehicle management control unit 23 calculates required cleaning time, refueling time, and battery charging time (hereinafter referred to as “required preparation time”) for each of the vehicles 40 on the basis of the vehicle information received from each of the vehicles 40 in the above step ST1. The calculated required preparation time for each of the vehicles 40 is stored in the operation management database 24a.

Thereafter, the flow proceeds to step ST26. In step ST26, the vehicle management control unit 23 searches for a vehicle 40 that can secure the calculated required preparation time on the basis of the received vehicle information. Then in step ST27, the vehicle management control unit 23 selects at least one vehicle 40 as a candidate vehicle 40 that the user can use out of the searched vehicles 40. The vehicle management control unit 23 includes the information of the candidate vehicle 40 in the operation plan information.

On the other hand, if it is determined that neither a battery charging facility nor a fueling facility is available in the searched overnight stay parking lot in step ST22, the vehicle management control unit 23 proceeds to step ST28. In step ST28, the vehicle management control unit 23 sets to perform the power train control, which is travel control that suppresses reduction of the state of charge by charging the battery as much as possible in the vehicle 40 on the basis of the traveling route searched in the above step ST3. In other words, the accommodation vehicle 40 includes a rechargeable battery, and in the case where neither a facility capable of charging the battery nor a facility capable of refueling the accommodation vehicle 40 is available in the overnight stay parking lot selected in the operation plan, the travel control in the operation plan is set to suppress consumption of the electric power from the battery in the accommodation vehicle 40. The vehicle management control unit 23 plans a plurality of operation plans that allows the battery in the vehicle 40 to be charged as much as possible. The operation plan in this case implements in the vehicle 40 a plan to use at least one of the electric power and fuel that enables maintaining a state where the engine of the vehicle 40 is not used during a preset time period such as a bedtime or a time period during which the safety verification process is performed. In other words, the accommodation vehicle 40 includes an engine capable of generating electricity, and the operation plan includes a plan to use at least one of the electric power and fuel that enables maintaining a state where the engine is not used during a preset time period. That is, the vehicle management control unit 23 plans an operation plan in which the state of charge of the battery of the vehicle 40 does not reach zero for a set time while the vehicle 40 is parked in the overnight stay parking lot 60.

Thereafter, moving on to step ST24, the vehicle management control unit 23 calculates the amount of energy required from the departing location to the overnight stay parking lot on the basis of the plurality of operation plans set to perform power train control under which the battery is charged as much as possible. Then, steps ST25 to ST27 are similar to the above-described processing. The operation plan list, which is information of the plurality of operation plans planned in the above manner, is transmitted to the user terminal device 50 after step ST6 in FIG. 8. Along with this, the vehicle managing apparatus 20 transmits charge information corresponding to each of the operation plans in the operation plan list to the user terminal device 50.

Subsequently, in step ST7, the user selects a desired operation plan from a plurality of operation plans in the user terminal device 50. Here, charge information depending on the operation plan is also transmitted to the user terminal device 50. An example of this charge information is charge information based on the above-described table of charges illustrated in FIG. 3.

Here, the charge information will be described. In the example of the charge information illustrated in FIG. 3, for example, eight charge levels of S1, S2, A1, A2, B1, B2, C1, and C2 are set as charges. These charge levels can be defined as, for example, S1>S2>A1>A2>B1>B2>C1>C2. Specifically explaining an example, in the case where a boarding location in a suburb and an alighting location is in a city center, and parking the vehicle 40 in a suburban parking lot 60 is more reasonable as compared to parking the vehicle 40 in a city center parking lot 60, as for an overnight stay timing, the charge can be lower for an overnight stay with the vehicle 40 parked in the suburban parking lot 60 before traveling. Furthermore, as for parking lots 60 for parking the vehicle 40 at times of staying overnight or for other activities in suburbs, there are cases where a parking fee is more reasonable for parking lots such as coin-operated parking (suburban P in FIG. 3) than parking lots of stores (suburban store P in FIG. 3). Therefore, depending on which of parking lots 60 having different parking fees the overnight stay parking lot corresponds to, charges corresponding to those parking fees can be set. Note that the store P includes parking lots of commercial facilities such as hot spring facilities, supermarkets, shopping malls, amusement parks, manga café s, movie theaters, night clubs, and gas stations. In addition, in the case where the store P is selected as the parking lot 60 to be used at the time of staying overnight or for other activities, it is also possible to collect introduction fee or the like from the commercial facility of the store P. Furthermore, the charge setting may vary depending on the days of the week. For example, it is possible to set the charges higher for cases where a boarding day or an alighting day is a holiday than for cases a boarding day or an alighting day is a weekday.

In and after step ST7, the operation plan information selected by the user is transmitted from the user terminal device 50 to the vehicle managing apparatus 20 together with the user identification information. Thereafter, in step ST8, the vehicle managing apparatus 20 performs processing of confirming the operation plan on the basis of the received user identification information and the selected operation plan information. The confirmed operation plan information is stored in the operation management database 24a in association with the user identification information.

The vehicle managing apparatus 20 transmits, to the parking lot managing center 30, reservation information including information of a so-called final reservation that ensures a state where the vehicle 40 for the user can park in the parking lot at a predetermined time point and a time period based on the operation plan on the basis of parking lot information included in the operation plan selected by the user. As a result, in step ST9, the parking lot managing center 30 makes a so-called final reservation that prevents other vehicles from making a reservation at the time point and the time period when the vehicle 40 parks in the parking lot on the basis of the operation plan of the vehicle 40. The reservation information is stored in the parking lot management database 34a in association with the vehicle identification information of the vehicle 40. The parking lot managing center 30 switches the provisionally reserved parking lot described above to a vacant parking lot that allows other vehicles to park at the date and time and the time period which have been initially provisionally reserved. The parking lot managing center 30 transmits a signal indicating completion of the final reservation of the parking lot to the vehicle managing apparatus 20.

Meanwhile, after the operation plan has been confirmed, the vehicle managing apparatus 20 transmits a vehicle assignment approval signal for approval of assigning the vehicle 40 selected by the user, charge information, and electronic key data to the user terminal device 50. In step ST10, the user terminal device 50 receives the electronic key data. Here, the electronic key functions as a release key in the user terminal device 50 for entering the vehicle 40 to drive or use the vehicle 40 by various communication means such as Bluetooth (registered trademark) and near field communication (NFC).

Upon receipt of the signal indicating completion of the final reservation of the parking lot 60, the vehicle managing apparatus 20 transmits a signal of vehicle assignment instruction to the vehicle 40 selected by the user. In step ST11, the vehicle 40 receives information of the vehicle assignment instruction. Then, a predetermined worker or another person moves the vehicle 40 to an assigning location, that is, the boarding location of the user. As described above, the vehicle 40 is assigned to and driven to the user under control of the vehicle management system 1.

Thereafter, in step ST12, the user unlocks the assigned vehicle 40 using the electronic key data in the user terminal device 50 to instruct the vehicle 40 to depart. The passengers including the user board the vehicle 40. When a passenger switches the ignition of the vehicle 40 on or inputs a signal of a departure instruction into the vehicle terminal device 41 to prepare the departure, the vehicle 40 is in the departure enabling state.

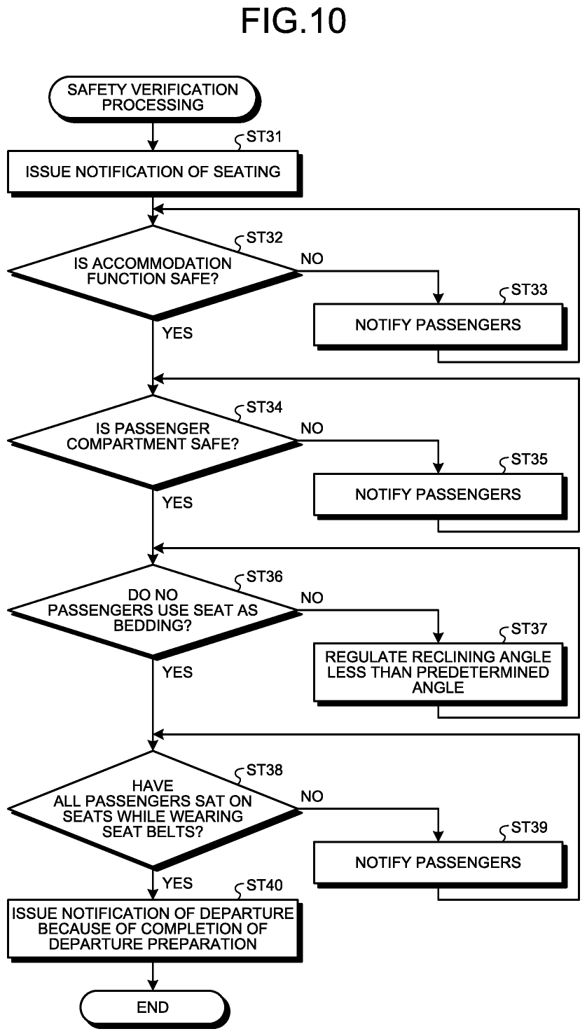

In step ST13, the vehicle 40 performs the safety verification process. Here, a specific exemplary safety verification processing method will be described. FIG. 10 is a flowchart for describing the safety verification processing method illustrated in FIG. 8. An example in which the vehicle 40 performs the safety verification process at the boarding location of the user will be given in the following. The safety verification process can be appropriately performed at any timing before traveling. The timing of performance of the safety verification process is included in the operation plan.

As illustrated in FIG. 10, in step ST31 in the safety verification processing method according to the embodiment, the safety verification unit 70 first prompts the passengers to be seated through the input and output unit 48 in the vehicle 40. In step ST31, while the departure-preparation verification unit 71 outputs the departure enabling signal, the accommodation-function safety determination unit 72 of the safety verification unit 70 has not yet output the accommodation-function safety signal, and the passenger-compartment safety determination unit 73 has not yet output the passenger-compartment safety signal. Then, the processing proceeds to step ST32.

At Step ST32, the accommodation-function safety determination unit 72 of the safety verification unit 70 determines whether the accommodation functional unit of the vehicle 40 is safe, based on the information supplied from the compartment interior sensor 43 and the image capturing unit 44. In a case where the accommodation-function safety determination unit 72 determines that the accommodation functional unit is not safe (Step ST32: No), the processing proceeds to Step ST33. In step ST33, the accommodation-function safety determination unit 72 supplies the input and output unit 48 with the accommodation-function failure signal. The input and output unit 48 notifies the passengers in the passenger compartment of information indicating that the accommodation functional unit should be made safe. After that, the processing goes back to Step ST32. Steps ST32 and ST33 are repeatedly performed until the accommodation-function safety determination unit 72 determines that the accommodation functional unit is safe. In a case where the accommodation-function safety determination unit 72 determines that the accommodation functional unit is safe (Step ST32: Yes), the processing proceeds to Step ST34.

In step ST34, the passenger-compartment safety determination unit 73 of the safety verification unit 70 determines whether the accommodation unfunctional object inside the vehicle 40 is safe, based on the information supplied from the compartment interior sensor 43 and the image capturing unit 44. In a case where the passenger-compartment safety determination unit 73 determines that the accommodation unfunctional object in the passenger compartment is not safe (Step ST34: No), the processing proceeds to Step ST35. In Step ST35, the passenger-compartment safety determination unit 73 supplies the input and output unit 48 with the passenger-compartment failure signal. The input and output unit 48 notifies the passengers in the passenger compartment of information indicating that the passenger compartment should be made safe. After that, the processing goes back to Step ST34. Steps ST34 and ST35 are repeatedly performed until the passenger-compartment safety determination unit 73 determines that the passenger compartment is safe. Meanwhile, in a case where the passenger-compartment safety determination unit 73 determines that the passenger compartment is safe (Step ST34: Yes), the processing proceeds to Step ST36.

In step ST36, the passenger-compartment safety determination unit 73 determines whether a passenger using the seat as the bed, namely, the bedding in the seat mechanism unit 42 is present. In other words, the passenger-compartment safety determination unit 73 determines whether a seat having a reclining angle not less than the predetermined angle set as the while-asleep reclining angle is present in the seat mechanism unit 42. The passenger-compartment safety determination unit 73 determines that the reclining angle of at least one seat in the seat mechanism unit 42 is not less than the predetermined angle (Step ST36: No), the processing proceeds to step ST37.

In step ST37, the passenger-compartment safety determination unit 73 outputs the angle control signal to the seat mechanism unit 42. In the seat mechanism unit 42 having the angle control signal input, the reclining angle of each seat is automatically restricted to less than the predetermined angle. With this, the backrest and the seat portion surface of a seat having a reclining angle not less than the predetermined angle are caused to operate such that the reclining angle is less than the predetermined angle. This is because, in a case where the reclining angle of at least one seat is not less than the predetermined angle in the seat mechanism unit 42, there is a possibility that a passenger is using the seat as the bedding in the passenger compartment. Note that, preferably, the operation of the backrest and the seat portion is automatically performed. However, the input and output unit 48 may notify the passengers of information indicating that the reclining angle should be made less than the predetermined angle, so that the passengers may perform the operation. After that, the processing goes back to Step ST36.

In step ST36, in a case where the passenger-compartment safety determination unit 73 determines that the reclining angles of all the seat in the seat mechanism unit 42 are less than the predetermined angle (Step ST36: Yes), the processing proceeds to step ST38.

In step ST38, the occupant-seat determination unit 74 determines whether all the passengers have been seated on the respective seats with the seat belts fastened in the passenger compartment, based on the information supplied from the compartment interior sensor 43 and the image capturing unit 44. In a case where the occupant-seat determination unit 74 determines that at least one passenger has not been seated on the seat or has not had the seat belt fastened (Step ST38: No), the processing proceeds to Step ST39. At Step ST39, the occupant-seat determination unit 74 outputs the departure failure signal outward, to notify the passengers in the passenger compartment through the input and output unit 48. After that, the processing goes back to step ST38. Steps ST38 and ST39 are repeatedly performed until the occupant-seat determination unit 74 determines that all the passengers have been seated on the seat with the seat belts fastened. In a case where the occupant-seat determination unit 74 determines that all the passengers have been seated on the seat with the seat belts fastened (Step ST38: Yes), the processing proceeds to step ST40.

In step ST40, the safety verification unit 70 outputs the departure signal, to notify the passengers in the passenger compartment of departure of the vehicle 40 because of completion of departure preparation, through the input and output unit 48. Then, the safety verification process finishes. Favorably, the safety verification process in step ST13 described above is included in the operation plan, and the state of no use of the engine of the vehicle 40 is retained during the period of time of performance of the safety verification process as the previously set period of time. In other words, preferably, the safety verification process is performed while the engine of the vehicle 40 is not operating.

When the safety verification process is finished, the processing proceeds to step ST14 illustrated in FIG. 8. In step ST14, the user on board the vehicle 40 departs for the alighting location that is the destination, in accordance with the operation plan information created in step ST6. In accordance with the operation plan from the boarding location to the alighting location, created according to either the powertrain control of charging the battery as much as possible or the powertrain control giving priority to the damping characteristic described above, the vehicle 40 heads for the parking lot 60 for staying. The seat mechanism unit 42 is in the seat mode in traveling the vehicle 40, and each passenger can change the reclining angle of the seat free in the range less than the predetermined angle in the bed mode.

After that, the vehicle 40 arrives at the parking lot 60 for staying that is the place of staying included in the operation plan. Then, each passenger can make an in-vehicle stay with the vehicle 40 parked in the parking lot 60 for staying. In this case, the controller 45 serving as a parking determination unit determines whether the vehicle 40 has been parked in the parking lot 60 for staying that is the place of staying, based on the location information supplied from the GPS unit 49 and the detection information from the various sensors of the vehicle 40. When the controller 45 determines that the vehicle 40 has been parked in the parking lot 60 for staying, the safety verification unit 70 performs control of releasing the regulation of the reclining angle of each seat, to the seat mechanism unit 42. With this, the reclining angle of each seat of the seat mechanism unit 42 is set to be the angle in the bed mode that is the predetermined angle set as while-asleep the reclining angle.

Note that, for example, in a case where the passengers get on board at the parking lot 60 for staying, the controller 45 or the safety verification unit 70 determines that each passenger makes an in-vehicle stay before the vehicle 40 moves, at the point of time the passengers including the user are on board the vehicle 40 on the basis of the operation plan information in step ST12. In this case, the controller 45 or the safety verification unit 70 controls the reclining angle of each seat of the seat mechanism unit 42, at the predetermined angle, thereby to place the seat mechanism unit 42 in the bed mode. Meanwhile, in a case where it is determined that each passenger makes an in-vehicle stay after the vehicle 40 moves, the controller 45 or the safety verification unit 70 makes the reclining angle of each seat changeable in the range less than the predetermined angle in the bed mode, thereby to place the seat mechanism unit 42 in the seat mode. With this, the seat mechanism unit 42 is kept in compliance with the legislation, in traveling of the vehicle 40.

According to the embodiment described above, because the seat mechanism unit 42 is placed in the seat mode and the reclining angle is restricted to less than the predetermined angle set as the while-asleep reclining angle, before traveling of the vehicle 40, the vehicle 40 can travel in compliance with the legislation.

According to the embodiment, the vehicle managing apparatus 20 can create, as the operation plan, a plan for electric power consumption in the battery of the vehicle 40 and fuel consumption in the engine of the vehicle 40, in accordance with the facility of the parking lot 60 for parking, for example, during staying. This can reduce the possibility that the electric power of the battery of the vehicle 40 runs short while the user is staying overnight inside the vehicle 40.

Although the embodiment of the present disclosure has been specifically described above, the present disclosure is not limited to the embodiment described above, and various modifications based on the technical idea of the present disclosure may be employed. For example, the configurations of the respective devices described in the above embodiment is merely an example, and a configuration different from the above may be used as necessary.

For example, information transmitted and received among the vehicle managing apparatus 20, the parking lot managing center 30, the respective vehicles 40, and the respective user terminal devices 50 according to the embodiment described above is not necessarily limited to the information described above, and information different from the above may be transmitted and received as necessary.

For example, the vehicles 40 used in the embodiment described above is not limited to the camper but may include various accommodation vehicles as long as staying overnight in the vehicle is possible. For example, the vehicles 40 may include an accommodation vehicle that can be autonomously operated (automatically operated), an accommodation vehicle operated by another driver, a lodging bus or a large-sized vehicle in which staying overnight is possible, and the like. Moreover, the vehicle 40 may be of any type including a hybrid vehicle having both an engine and a motor, a conventional vehicle having an engine but without a motor, and an EV vehicle having a motor but without an engine.

Furthermore, the processing method of assigning a vehicle by the vehicle managing system 1 that is executed according to the above embodiment is not limited to the order mentioned above, and the order of the steps can be modified as long as the processing method of assigning a vehicle can be executed. For example, the transmission of the vehicle assignment approval signal, the charge information, and the electronic key data may be performed after the final reservation of the overnight stay parking lot 60 is completed.

In the embodiment described above, the example has been described in which, a plan for consuming electric power in the battery of the vehicle 40 and consuming fuel in the engine of the vehicle 40 is generated depending on the facilities in the parking lot 60 to park at the time of staying overnight or for other activities; however, this is not necessarily limited to the case of staying overnight. Specifically, the present disclosure can be similarly applied to a case where an accommodation vehicle is stopped at a predetermined parking lot and a driver or other passengers perform other works. In addition, the time period during which the vehicle 40 is parked is not necessarily limited to nighttime, and the present disclosure can be similarly applied even the case where the time period for parking is daytime.

An accommodation vehicle management apparatus, an accommodation vehicle management system, and an accommodation vehicle according to the present disclosure, restrict, in traveling, the reclining angle of a seat less than a predetermined angle set as a reclining angle in sleeping, resulting in satisfaction of the legislation in boarding of the passenger who uses the seat.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An accommodation vehicle management apparatus configured to manage an accommodation vehicle including a reclinable seat in which a passenger sits, the reclinable seat being usable as bedding on which the passenger lies, and the accommodation vehicle being movable, the accommodation vehicle management apparatus comprising:
a first hardware processor configured to restrict a reclining angle of the reclinable seat to less than a predetermined angle set as a reclining angle at the time of the reclinable seat being used as the bedding, at least while the accommodation vehicle is moving.

2. The accommodation vehicle management apparatus according to claim 1, wherein the first hardware processor is further configured to
determine whether the accommodation vehicle has been parked in a parking area for staying, and
release the restriction of the reclining angle of the reclinable seat, in a case where it is determined that the accommodation vehicle has been parked for staying.

3. The accommodation vehicle management apparatus according to claim 2,
wherein, at a point of time the passenger is on board the accommodation vehicle, the first hardware processor is further configured to
set the reclining angle of the reclinable seat to the predetermined angle set as the reclining angle at the time of the reclinable seat being used as the bedding, in a case where the passenger stays in the accommodation vehicle having been parked in the parking area for staying before the accommodation vehicle moves, and
restrict the reclining angle of the seat to less than the predetermined angle set as the reclining angle at the time of the reclinable seat being used as the bedding, in a case where the passenger stays in the accommodation vehicle after the accommodation vehicle moves to the parking area for staying.

4. The accommodation vehicle management apparatus according to claim 1, further comprising a second hardware processor configured to:
receive information including boarding and alighting location information, from a user terminal that is usable by the passenger to use the accommodation vehicle which further includes an engine configured to generate electric power,
select a parking area for staying from the received information, and
create an operation plan including a usage plan of at least one of electric power and fuel in accordance with a facility of the selected parking area for staying, wherein the operation plan includes the usage plan that disables use of the engine during a previously determined period of time.

5. The accommodation vehicle management apparatus according to claim 1, further comprising:
a third hardware processor configured to
receive information including boarding and alighting location information, from a user terminal that is usable by the passenger for use of the accommodation vehicle,
select a parking area for staying from the received information,
create an operation plan including a usage plan of at least one of electric power and fuel in accordance with a facility of the selected parking area for staying, select the accommodation vehicle usable along the operation plan,
calculate a charge in accordance with the operation plan, and
transmit vehicle information regarding the selected accommodation vehicle and charge information regarding the calculated charge, to the user terminal,
wherein the third hardware processor is further configured to determine the charge differently between in a case where the accommodation vehicle is parked before moving to an alighting location according to the operation plan and in a case where the accommodation vehicle is parked after moving to an alighting location according to the operation plan, the alighting location being included in alighting location information included in the boarding and alighting location information received from the user terminal.

6. An accommodation vehicle management system comprising:
an accommodation vehicle including a reclinable seat in which a passenger sits, the reclinable seat being usable as bedding on which the passenger lies, and the accommodation vehicle being movable; and
a first hardware processor configured to
communicate with the accommodation vehicle, and
manage the accommodation vehicle; and
a second hardware processor configured to restrict a reclining angle of the reclinable seat to less than a predetermined angle set as a reclining angle at the time of the reclinable seat being used as the bedding, at least while the accommodation vehicle is moving.

7. An accommodation vehicle being movable comprising:
a reclinable seat in which a passenger sits, the reclinable seat being usable as bedding on which the passenger lies; and
a hardware processor configured to restrict a reclining angle of the reclinable seat to less than a predetermined angle set as a reclining angle at the time of the reclinable seat being used as the bedding, at least while the accommodation vehicle is moving.
